(19) United States
(12) Patent Application Publication
(10) Pub. No.: US 2016/0214887 A1
(43) Pub. Date: Jul. 28, 2016

(54) METHOD FOR MANUFACTURING A MATERIAL INCLUDING A SUBSTRATE HAVING A TIN AND INDIUM OXIDE-BASED FUNCTIONAL LAYER

(71) Applicant: SAINT-GOBAIN GLASS FRANCE, Courbevoie (FR)

(72) Inventors: Benoît ILLY, Compiegne (FR); Anne LORREN, Paris (FR); Sébastien ROY, Le Mesnil Saint Denis (FR); Driss LAMINE, Antony (FR)

(21) Appl. No.: 14/916,825

(22) PCT Filed: Sep. 4, 2014
(86) PCT No.: PCT/FR2014/052184

§ 371 Date: Mar. 4, 2016

(30) Foreign Application Priority Data
Sep. 5, 2013 (FR) 1358507

(51) Int. Cl. C03C 17/245; F24C 15/04; C03C 17/34

(52) U.S. Cl. CPC C03C 17/245; C03C 17/3435; C03C 17/2456; F24C 15/04; C03C 2217/948; C03C 2218/156

(57) ABSTRACT

A process for the manufacture of a material including a glass or glass-ceramic substrate provided, on at least one of its faces, with a stack of thin layers including a functional layer based on indium tin oxide, the process including successively depositing the functional layer and then, under a pressure of at most 2.5 μbar, an oxygen barrier layer by magnetron cathode sputtering on the at least one face of the substrate.

The invention relates to the field of materials comprising a glass or glass-ceramic substrate provided, on at least one of its faces, with a stack of thin layers comprising at least one functional layer based on indium tin oxide.

These functional layers, because of their low emissivity, exhibit the advantage of reducing heat exchanges through the material which is coated with them. This effect can be of use in the field of glazings in order to reduce energy consumption related to the heating of the building: this is because, by reflecting infrared radiation, the functional layer limits energy losses.

Such an advantage can also be turned to good account in applications at higher temperature, for example in domestic oven doors, fire-resistant doors or glazings, fireplace inserts, and the like. In these applications, such functional layers make it possible to improve the safety of the users by reducing the external temperature of the door, glazing or insert. Standards stipulate, for example in the case of domestic oven doors, temperatures of at most 70° C. on the outside of the door. The presence of such a layer also makes it possible to reduce the energy consumption of domestic ovens.

The low emissivity properties of indium tin oxide (also known as ITO) are correlated with its electron conduction properties, which depend greatly on the degree of oxidation of the ITO. An excessively high oxidation of the ITO results in a fall in its conductivity and thus in a large increase in its emissivity.

The high-temperature heat treatments used in the manufacture of the materials have the effect of oxidizing the ITO. These heat treatments, typically tempering or bending treatments, employ temperatures of the order of 600° C. and more. In order to prevent this, layers acting as barrier to oxidation are normally deposited above the functional layers and this solution has proved to be satisfactory in the case of glazings for the building industry or the motor vehicle industry.

However, it has turned out that these oxygen barrier layers are insufficient in the case where the material, due to its use, has to be brought to a relatively high temperature for lengthy periods, in particular in the case of domestic oven doors or fireplace inserts. This is because, after approximately one hundred hours of use at temperatures of greater than 250° C., the known stacks lose their low emissivity properties, despite the presence of barrier layers. This aging phenomenon prevents any use of

ITO-based stacks in applications employing high temperatures for lengthy periods.

The aim of the invention is to overcome these disadvantages by providing a material not exhibiting this aging phenomenon, that is to say a material capable of retaining, over time, its low-e properties under high temperature conditions.

To this end, a subject matter of the invention is a process for the manufacture of a material comprising a glass or glass-ceramic substrate provided, on at least one of its faces, with a stack of thin layers comprising a functional layer based on indium tin oxide, in which said functional layer and then, under a pressure of at most 2.5 μbar, an oxygen barrier layer are successively deposited by magnetron cathode sputtering on said at least one face of said substrate.

Another subject matter of the invention is a material capable of being obtained according to the process of the invention.

Another subject matter of the invention is a domestic oven door, in particular a pyrolysis oven door, or a fireplace insert, or a fire-resistant door or glazing, comprising at least one material according to the invention.

Finally, a subject matter of the invention is a process for the manufacture of a domestic oven door, in particular a pyrolysis oven door, or of a fireplace insert, or of a fire-resistant door or glazing, comprising a stage employing the process described above.

This is because the inventors have been able to demonstrate that, during the deposition by magnetron cathode sputtering of the oxygen barrier layer, the application of particularly low pressure in the deposition chamber makes it possible to obtain stacks for which the emissivity remains particularly stable at high temperature and over a long period of time.

The stack of thin layers deposited on the substrate comprises a functional layer based on indium tin oxide and an oxygen barrier layer. In the simplest scenario, the stack comprises only a single functional layer. The stack can also comprise other functional layers and/or other oxygen barrier layers. In the latter case, it is sufficient for one of the oxygen barrier layers to be deposited at low pressure. The stack can also comprise other layers, as explained in more detail in the continuation of the text. It should be made clear here and now that the oxygen barrier layer may or may not be in contact with the functional layer and that the functional layer may or may not be in contact with the substrate.

The glass substrate is preferably made of soda-lime-silica, borosilicate, aluminosilicate or alumino-borosilicate glass.

The chemical composition of the soda-lime-silica glass typically comprises (as percentages by weight) from 60 to 80% of SiO₂, from 3 to 15% of CaO and from 7 to 18% of Na₂O.

The soda-lime-silica glass can also be a glass exhibiting an improved thermal resistance, as described in the application WO 98/00508.

The chemical composition of the borosilicate glass preferably comprises (or is essentially composed of) the following constituents, varying within the weight limits defined below:

| | |
|---|---|
| SiO₂ | 70-85%, in particular 75-85% |
| B₂O₃ | 8-16%, in particular 10-15% |
| Al₂O₃ | 0-5%, in particular 0-3% |
| K₂O | 0-2%, in particular 0-1% |
| Na₂O | 1-8%, in particular 2-6%. |

Preferably, the composition can additionally comprise at least one of the following oxides: MgO, CaO, SrO, BaO or ZnO, in a total content by weight ranging from 0 to 10%.

The chemical composition of the alumino-borosilicate glass preferably comprises silica SiO₂ in a content by weight ranging from 45 to 68%, alumina Al₂O₃ in a content by weight ranging from 8 to 20%, boron oxide B₂O₃ in a content by weight ranging from 4 to 18% and alkaline earth oxides chosen from MgO, CaO, SrO and BaO in a total content ranging from 5 to 30%, the total content by weight of alkali metal oxides not exceeding 10%, in particular 1%, indeed even 0.5%. The chemical composition of the alumino-borosilicate glass preferably comprises (or is essentially composed of) the following constituents, varying within the weight limits defined below:

| | |
|---|---|
| SiO₂ | 45-68%, in particular 55-65% |
| Al₂O₃ | 8-20%, in particular 14-18% |
| B₂O₃ | 4-18%, in particular 5-10% |
| RO | 5-30%, in particular 5-17% |
| R₂O | at most 10%, in particular 1%. |

As is customary in the art, the expression “RO” denotes the alkaline earth oxides MgO, CaO, SrO and BaO, while the expression “R₂O” denotes the alkali metal oxides.

The glass-ceramic substrate is preferably made of a glass ceramic of the lithium aluminosilicate type comprising crystals of β-quartz structure and a glassy phase. Such glass ceramics exhibit linear thermal expansion coefficients of approximately zero, with the result that they are extremely resistant to thermal shocks.

The chemical composition of such a glass ceramic preferably comprises (or is essentially composed of) the following constituents, varying within the weight limits defined below:

| | |
|---|---|
| SiO₂ | 49-75% |
| Al₂O₃ | 15-30% |
| Li₂O | 1-8% |
| K₂O | 0-5% |
| Na₂O | 0-5% |
| ZnO | 0-5% |
| MgO | 0-5% |
| CaO | 0-5 |
| BaO | 0-5% |
| SrO | 0-5% |
| TiO₂ | 0-6% |
| ZrO₂ | 0-5% |
| P₂O₅ | 0-10% |
| B₂O₃ | 0-5%. |

The glass or glass-ceramic substrate is preferably transparent and colorless (it is then a clear or extra-clear glass). A clear glass typically comprises a content by weight of iron oxide of the order of from 0.05 to 0.2%, whereas an extra-clear glass generally comprises approximately from 0.005 to 0.03% of iron oxide. The glass can be colored, for example in blue, green, gray or bronze, but this embodiment is not preferred. The thickness of the substrate is generally within the range extending from 0.5 mm to 19 mm, preferably from 0.7 to 9 mm, in particular from 2 to 8 mm, indeed even from 4 to 6 mm.

The glass substrate is preferably of the float glass type, that is to say capable of having been obtained by a process consisting in pouring the molten glass over a bath of molten tin (float bath). In this case, the stack can equally well be deposited on the “tin” face as on the “atmosphere” face of the substrate. “Atmosphere” face and “tin” face are understood to mean the faces of the substrate which have respectively been in contact with the atmosphere prevailing in the float bath and in contact with the molten tin. The tin face comprises a small superficial amount of tin which has diffused into the structure of the glass.

When the substrate is made of glass, the material according to the invention is preferably heat tempered in order to impart to it improved properties of thermo-mechanical resistance. As described subsequently, the heat tempering is also of use in order to improve the emissivity properties of the ITO layer.

The (or, if appropriate, each) functional layer based on indium tin oxide is preferably essentially composed, indeed even consists, of such an oxide.

The atomic percentage of Sn is preferably within a range extending from 5 to 70%, in particular from 6 to 60% and advantageously from 8 to 12%.

In comparison with other low-e layers, such as fluorine-doped tin oxide, ITO is valued for its high electrical conductivity, allowing the use of low thicknesses in order to obtain a good level of emissivity. The materials obtained thus exhibit a high light transmission, which is noticeable in the applications targeted. In addition, ITO can be easily deposited by magnetron cathode sputtering, with a good yield and a good rate of deposition.

The physical thickness of the functional layer is to be adjusted as a function of the emissivity desired. This physical thickness is preferably within a range extending from 50 to 300 nm, in particular from 70 to 200 nm, indeed even from 80 to 150 nm. The emissivity is closely correlated with the sheet resistance, which is easier to measure. The sheet resistance of the functional layer is preferably within a range extending from 10 to 30 Ω.

The degree of oxidation of the functional layer is preferably such that the “LA/t” ratio of the light absorption of the stack to the physical thickness of the functional layer (expressed in μm) is within a range extending from 0.20 to 0.60, in particular from 0.25 to 0.50. For example, for a light absorption of 3% for a physical thickness of 100 nm (=0.1 μm), this ratio has the value 0.03/0.1=0.3. The light absorption of the stack is calculated by subtracting the light absorption in the substrate from the total light absorption. For its part, the latter is calculated by subtracting, at the value of 1, the light transmission and the light reflection within the meaning of the standard ISO 9050:2003.

The light absorption is preferably measured after heat tempering.

The degree of oxidation of the functional layer can be optimized by adjusting, if appropriate, the oxygen flow rate during the deposition of the layer, by adjusting the parameters of the heat tempering (a high temperature or a longer time promoting the oxidation of the layer) or also by modifying the nature and the thickness of the layers located under or above the functional layer.

The light absorption is correlated with the degree of oxidation of the functional layer: the lower the light absorption of the layer, the greater the oxidation of the layer. When the degree of oxidation of the functional layer increases, the resistivity begins by decreasing until a minimum is reached and then subsequently increases in a very abrupt manner. The abovementioned choice of light absorption (and thus of degree of oxidation) makes it possible to prevent any rapid increase in the resistivity as a possible oxidation of the functional layer (case of exceptional aging) would be reflected only by an additional decrease in the resistivity and thus in the emissivity. On the other hand, for LA/t ratios of less than 0.2 μm⁻¹, an even slight oxidation can result in a significant increase in the resistivity.

The oxygen barrier layer is preferably based on (or essentially composed of) a material chosen from nitrides or oxynitrides, in particular silicon or aluminum nitrides or oxynitrides, or from titanium, zirconium or zinc oxides, or tin and zinc mixed oxides.

Possible materials are in particular silicon nitride, aluminum nitride, silicon oxynitride, aluminum oxynitride, titanium oxide, zirconium oxide, zinc oxide, zinc tin oxide or any one of their mixtures.

Very preferably, the oxygen barrier layer is based on silicon nitride, in particular is essentially composed of silicon nitride. This is because silicon nitride constitutes a very effective barrier to oxygen and can be rapidly deposited by magnetron cathode sputtering. The name “silicon nitride” is not detrimental to the presence of other atoms than silicon and nitrogen, or to the true stoichiometry of the layer. This is because silicon nitride preferably comprises a small amount of one or more atoms, typically aluminum or boron, added as dopants to the silicon targets used with the aim of increasing their electron conductivity and of thus facilitating the deposition by magnetron cathode sputtering. The silicon nitride can be stoichiometric in nitrogen, sub-stoichiometric in nitrogen or also superstoichiometric in nitrogen.

In order to fully play its role of barrier to oxygen, the oxygen barrier layer (in particular when it is based on or essentially composed of silicon nitride) preferably has a physical thickness of at least 3 nm, in particular 4 nm or 5 nm. Its physical thickness is advantageously at most 50 nm, in particular 40 or 30 nm.

Preferably, all of the stack is deposited by magnetron cathode sputtering.

The stack deposited on a face can comprise several functional layers and/or several oxygen barrier layers. For reasons of simplicity, it is, however, preferable for it to comprise only one functional layer. Likewise, the stack can comprise only one oxygen barrier layer, in particular based on or essentially composed of silicon nitride.

However, the material can be such that the substrate is coated on both its faces with a stack of the same nature. The process is then such that a functional layer and an oxygen barrier layer are deposited, by magnetron cathode sputtering, on each face of the substrate, the deposition of each oxygen barrier layer being carried out under a pressure of at most 2.5 μbar.

The stack of thin layers can be composed of the functional layer and of the barrier layer.

However, preferably, the stack of thin layers comprises at least one thin layer other than the functional layer and the barrier layer.

In all cases, the barrier layer is preferably in direct contact with the functional layer. The functional layer can be deposited in direct contact with the substrate. Alternatively, the stack can comprise at least one layer between the substrate and the functional layer.

The stack can in particular comprise, between the substrate and the functional layer, at least one neutralization layer or one neutralization stack of layers. In the case of a single layer, its refractive index is preferably between the refractive index of the substrate and the refractive index of the functional layer. Such layers or stacks of layers make it possible to influence the appearance in reflection of the material, in particular its color in reflection. Bluish colors, characterized by negative b* colorimetric coordinates, are generally preferred. As nonlimiting examples, it is possible to use a layer of silicon tin mixed oxide (SiSnOₓ), of silicon oxycarbide or oxynitride, of aluminum oxide, or of silicon titanium mixed oxide. A stack of layers comprising two layers respectively having a high index and a low index, for example a TiOₓ/SiOₓ, SiNₓ/SiOₓ or ITO/SiOₓ stack, can also be used, the layer having a high index being the layer closest to the substrate. The physical thickness of this or these layers is preferably within the range extending from 2 to 100 nm, in particular from 5 to 50 nm. The preferred neutralization layers or stacks are a neutralization layer made of a silicon oxynitride or an SiNₓ/SiOₓ stack.

The neutralization layer or stack is preferably in direct contact with the functional layer. Located between the latter and the substrate, it can also be used to block possible migration of ions, such as alkali metal ions.

It is possible to position an adhesion layer between the substrate and the neutralization layer or stack. This layer, which advantageously exhibits a refractive index similar to that of the glass substrate, makes it possible to improve the tempering behavior by promoting the attachment of the neutralization layer. The adhesion layer is preferably made of silica. Its physical thickness is preferably within a range extending from 20 to 200 nm, in particular from 30 to 150 nm.

The oxygen barrier layer can be the final layer of the stack and thus in contact with the atmosphere.

According to another embodiment, the stack can comprise at least one layer above the oxygen barrier layer.

It can in particular be a layer based on silicon oxide, advantageously a layer of silica, in order to reduce the light reflection of the stack. It is understood that the silica may be doped or may not be stoichiometric. By way of examples, the silica can be doped with aluminum or boron atoms, with the aim of facilitating its deposition by cathode sputtering processes.

The physical thickness of the layer based on silicon oxide is preferably within the range extending from 20 to 100 nm, in particular from 30 to 90 nm, indeed even from 40 to 80 nm.

It is also possible to deposit, above the oxygen barrier layer, if appropriate above the layer based on silicon oxide, a layer based on titanium oxide, the physical thickness of which is advantageously at most 30 nm, in particular 20 nm, indeed even 10 nm or even 8 nm. The presence of this layer makes it possible to reduce the sensitivity to scratching of the stack.

This layer is advantageously photocatalytic. Very thin photocatalytic layers, although less active photo-catalytically speaking, exhibit, however, good self-cleaning, dirt-repelling and antifogging properties. This is because, even for very thin layers, photocatalytic titanium oxide exhibits the distinguishing feature, when it is irradiated by sunlight, of becoming extremely hydrophilic, with contact angles with water of less than 5° and even 1°, which allows the water to flow down more easily, removing the dirt deposited at the surface of the layer. In addition, the thicker layers exhibit a greater light reflection.

The layer based on titanium oxide, in particular photocatalytic titanium oxide, is preferably a layer made of titanium oxide, in particular for which the refractive index is within a range extending from 2.0 to 2.5. The titanium oxide is preferably at least partially crystallized in the anatase form, which is the most active phase from the viewpoint of the photocatalysis. Mixtures of anatase and rutile phase have also proved to be very active. The titanium dioxide can optionally be doped with a metal ion, for example an ion of a transition metal, or with nitrogen, carbon, fluorine or the like atoms. The titanium dioxide can also be substoichiometric or super-stoichiometric.

In this embodiment, the entire surface of the photocatalytic layer, in particular based on titanium oxide, is preferably in contact with the exterior, so as to be able to fully apply a self-cleaning function. However, it can be advantageous to coat the photocatalytic layer, in particular made of titanium dioxide, with a thin hydrophilic layer, in particular based on silica, in order to improve the persistence of the hydrophilicity over time.

The various preferred embodiments described above can, of course, be combined with one another, even if all the possible combinations are not exclusively described in the present text in order not to needlessly expand it. The stack of thin layers can be composed, successively starting from the substrate, of a functional layer and of an oxygen barrier layer. It can also be composed, successively starting from the substrate, of a functional layer, of an oxygen barrier layer and of a photocatalytic layer. It can also be composed, successively starting from the substrate, of a neutralization stack composed of a high-index layer and then of a low-index layer, of a functional layer, of an oxygen barrier layer and of a photocatalytic layer. It can also be composed, successively starting from the substrate, of a neutralization stack composed of a high-index layer and then of a low-index layer, of a functional layer, of an oxygen barrier layer, of a layer based on silicon oxide and of a photocatalytic layer.

A few examples of particularly preferred stacks are given below:
1. Glass/(SiOₓ)/SiOₓN_{y}/ITO/SiNₓ/SiOₓ/(TiOₓ)
2. Glass/(SiOₓ)/SiNₓ/SiOₓ/ITO/SiNₓ/SiOₓ/(TiOₓ)
3. Glass/SiNₓ/SiOₓ/ITO/SiNₓ/(TiOₓ)

In these stacks, the physical thickness of the (optional) TiOₓ layer is advantageously at most 15 nm, indeed even 10 nm.

Stacks 1 to 3 are obtained by magnetron cathode sputtering. Examples 1 and 2 comprise, on the glass, an optional adhesion layer made of silica, then a neutralization layer made of silicon oxynitride or a neutralization stack composed of a silicon nitride layer surmounted by a silicon oxide layer, the functional layer based on ITO, the barrier layer made of silicon nitride, a layer made of silicon oxide and, finally, the photocatalytic layer made of titanium oxide (optional). Example 3 corresponds to example 2 but without the adhesion layer made of silica and without the layer based on silicon oxide deposited on the barrier layer. The formulae given are not prejudicial to the true stoichiometry of the layers, or to an optional doping. In particular, the silicon nitride and/or the silicon oxide is generally doped, for example with aluminum, as indicated above. The oxides and nitrides may not be stoichiometric (they may, however, be), hence the use in the formulae of the index “x”, which is, of course, not necessarily the same for all the layers.

The functional layer and the oxygen barrier layer, and preferably all the layers of the stack, are deposited by magnetron cathode sputtering.

In this process, a plasma is created under a high vacuum in the vicinity of a target (or cathode) comprising the chemical elements to be deposited. The active entities of the plasma, on bombarding the target, tear off said elements, which are deposited on the substrate with the formation of the thin layer desired. This process is said to be “reactive” when the layer is composed of a material resulting from a chemical reaction between the elements torn off from the target and the gas present in the plasma. The major advantage of this process lies in the possibility of depositing, on one and the same line, a highly complex stack of layers by successively passing the substrate forward under different targets, this being done generally in one and the same device. The device comprises several vacuum chambers, each comprising a given target. Depending on the thickness of the layer and the rate of deposition, it is sometimes necessary to use several successive chambers in order to deposit one and the same layer.

The cathode sputtering is preferably of the AC (alternating current), DC (direct current) or also pulsed DC type, according to the type of generator employed to polarize the cathode.

The deposition is preferably carried out on an unheated substrate.

The deposition of the oxygen barrier layer, when the latter is based on a metal nitride, is preferably carried out using a target of the metal in question, in an atmosphere composed of plasmagene gas (generally argon) and nitrogen.

Thus, for the deposition of an oxygen barrier layer based on or essentially composed of silicon nitride, use will preferably be made of a silicon target, generally doped with aluminum or boron in order to increase its electron conductivity, in an atmosphere composed of argon and nitrogen.

The pressure for deposition of the oxygen barrier layer (in particular based on or essentially composed of silicon nitride) is advantageously at most 2.4 μbar, in particular 2.3 μbar, indeed even 2.2 μbar and even 2.1 μbar or 2.0 μbar. “Pressure for deposition” is understood to mean the pressure prevailing in the chamber where the deposition of this layer is carried out. Excessively low pressures, which are difficult to achieve on an industrial deposition machine, do not, however, provide an additional advantage in terms of resistance to aging. Thus, the pressure for deposition during the deposition of the oxygen barrier layer is preferably at least 1.0 μbar, in particular 1.5 μbar.

The targets can be flat or, preferably, tubular (in the form of rotating tubes).

During the deposition of the oxygen barrier layer, the deposition power is preferably within a range extending from 0.5 to 4 kW/linear meter of target. For two tubular cathodes with a length of 3.8 m, the total power thus varies from 5 to 30 kW.

The rate of forward progression of the substrate under the different targets is typically within a range extending from 0.5 to 3 m/min.

During the deposition, the substrate is generally provided in the form of a large glass sheet of 3.2*6 m². After deposition, the substrate is cut to the desired measurements and the edges are shaped.

When the substrate is made of glass, the material is preferably subjected to a heat tempering intended to reinforce its thermomechanical resistance. The heat tempering makes it possible in addition to improve the crystallization of the functional layer made of ITO and to achieve good emissivity values. In order to do this, the substrate coated with the stack is brought to high temperature (typically above 600° C., indeed even 700° C. in the case of a substrate of soda-lime-silica glass) for several minutes and then suddenly cooled, in particular by projection of air.

The domestic oven door according to the invention preferably comprises at least two glass sheets, an internal glass sheet intended to be the glass sheet closest to the chamber of the oven and an external glass sheet, said glass sheets being kept united and being separated by at least one band of air.

The oven door according to the invention preferably comprises at least one intermediate glass sheet located between the internal glass sheet and the external glass sheet and separated from each of the latter by at least one band of air. The presence of intermediate sheets makes it possible to create additional bands of air which will further limit the temperature at the external sheet of the door. By virtue of these bands of air, cooling air flows will circulate between the glass sheets, contributing to the cooling thereof. The air flow can be forced, by combining the door with a ventilation device establishing a flow of air circulating from the lower edge of the door to the upper edge. Preferably, the oven door comprises one or two intermediate sheet(s) and the flow of air can circulate only between the intermediate sheet and the external sheet and, if appropriate, between the intermediate sheets.

The domestic oven door according to the invention thus preferably comprises three or four glass sheets, the second and/or the third glass sheet, starting from the internal glass sheet intended to be the glass sheet closest to the chamber of the oven, being a material according to the invention. When the oven door comprises three glass sheets, the second glass sheet, starting from the internal glass sheet intended to be the glass sheet closest to the chamber of the oven, is preferably a material according to the invention. When the oven door comprises four glass sheets, the second glass sheet and/or the third glass sheet, starting from the internal glass sheet intended to be the glass sheet closest to the chamber of the oven, is preferably a material according to the invention. The material according to the invention can be coated with the low-e stack described above on one face or on both its faces.

The glass sheets can be kept united by various mechanical devices. By way of example, the external glass sheet can be combined with a rectangular metal frame attached to its internal face (face turned towards the chamber of the oven), in which frame is housed the internal glass sheet and, if appropriate, the or each intermediate glass sheet. The internal and intermediate glass sheets can, for example, be inserted into grooves made in the frame. In this case, the external glass sheet preferably exhibits a surface area greater than the surface area of the other sheets of the door. The internal glass sheet can also be distorted at its periphery, for example using a burner, so that said periphery matches a flat surface parallel to the main surface of the glass sheet, this flat surface resting on the face of the frame opposite the face attached to the external glass sheet. Increasing the space between the glass sheets which results therefrom has the effect of increasing the flow of air.

In order to provide the abovementioned flow of air, the metal frame preferably has a plurality of longitudinal slits at the lower and upper edges of the door.

The internal and external glass sheets are kept parallel to one another, for example by means of the above-mentioned metal frame. The intermediate glass sheets may or may not be parallel to the internal and external glass sheets.

The external glass sheet is preferably coated on a portion of its external face (intended to face the user) with a decoration, in particular in the form of enamel deposited by screen printing, intended, for example, to mask the various components for attaching the glass sheets and to render visible only the interior of the chamber of the oven. The internal glass sheet can also be coated with an enamel decoration, for example deposited by screen printing, on the face which is turned towards the external sheet, in particular on its perimeter. In the case where the internal glass sheet is heat tempered, the firing of the enamel can take place during the tempering stage.

The thickness of the glass sheets (in particular of the internal glass sheet) is preferably within the range extending from 2 to 5 mm, in particular from 2.5 to 4.5 mm. Thicknesses of 3 or 4 mm are particularly advantageous in terms of cost, of weight and of thermal insulation of the door. The total thickness of the door is generally within a range extending from 6 to 50 mm, in particular from 15 to 40 mm.

The glass sheets generally exhibit a surface of rectangular shape, it being possible for the corners optionally to be rounded.

The fire-resistant glazings (also known as fire protection glazings) are preferably of class E30 or E60 or EW30 or EW60. They can be used equally well inside as outside, be single, laminated or multiple glazings or be incorporated in glass partitions or also facades.

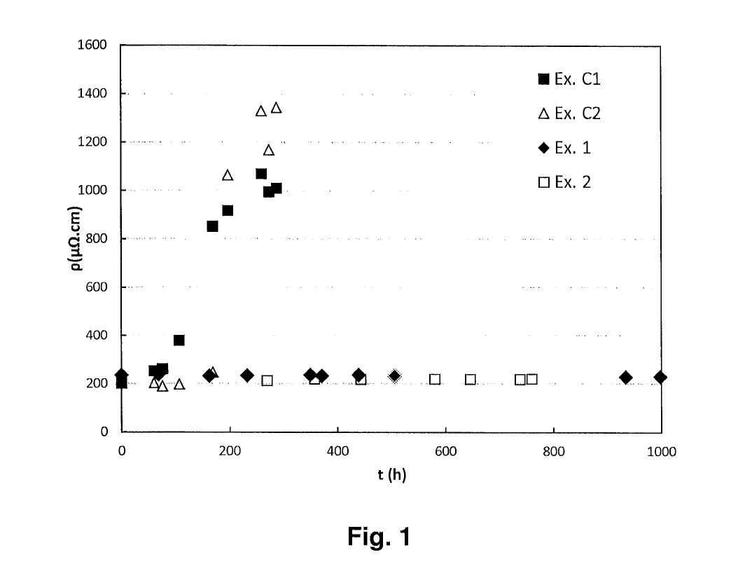

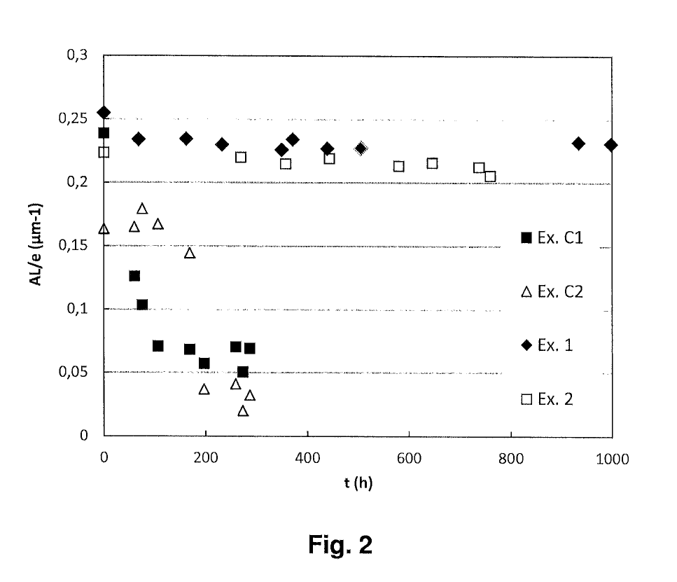

The examples which follow and also FIGS. 1 and 2 illustrate the invention without, however, limiting it.

### EXAMPLE 1

The following stack:

Glass/SiNₓ(2)/SiO₂(34)/ITO(118)/SiNₓ(6)/SiO₂(65)/TiO₂(3)

was deposited by AC cathode magnetron sputtering on a clear soda-lime-silica glass substrate with a thickness of 4 mm.

The figures between parentheses correspond to the physical thicknesses, expressed in nanometers.

The silicon oxide and silicon nitride layers were deposited using targets formed of silicon doped with aluminum (2 to 8 atom %) under an argon plasma with addition respectively of oxygen and nitrogen. The ITO layers were deposited using ITO targets under an argon plasma.

The SiNₓ barrier layer was deposited under a pressure of 2.0 μbar.

The materials obtained were subsequently heat tempered in a known way, by heating the glass at approximately 700° C. for a few minutes before rapidly cooling it using air nozzles. The LA/t ratio is 0.25.

### EXAMPLE 2

In this example, the stack is simplified, since it no longer comprises a silicon oxide layer above the barrier layer made of silicon nitride.

The thickness of the barrier layer is greater (10 nm), as well as the thickness of the TiO₂ layer (4 nm). The barrier layer made of silicon nitride was deposited at a pressure of 2.3 μbar. The LA/t ratio (after heat tempering) is 0.22.

### COMPARATIVE EXAMPLE 1 (C1)

In comparison with that of example 1, this stack does not comprise an oxygen barrier layer made of silicon nitride. The LA/t ratio after heat tempering is 0.24.

### COMPARATIVE EXAMPLE 2 (C2)

In comparison with example 1, the silicon nitride barrier layer was deposited under a higher pressure of 3.0 μbar. The LA/t ratio after heat tempering is 0.16.

### Aging Test

In order to study their resistance to aging, the various materials were placed in an oven at a temperature of 450° C. for periods of time which can range up to 2000 hours.

The following properties were measured:
the electrical resistivity of the functional layer, denoted ρ and expressed in μOhms·cm, calculated from the measurement of the sheet resistance and from the thickness of the ITO layer, the sheet resistance of the stack for its part being measured in a known way using a contactless measurement device sold by Nagy Messsysteme GmbH,
the light absorption of the stack, calculated by subtracting the light absorption of the substrate from the total light absorption, the latter for its part being calculated by subtracting, at the value of 1, the light transmission and the light reflection within the meaning of the standard ISO 9050:2003, measured using a spectrophotometer.

The results obtained are summarized in FIGS. 1 and 2, the test time (expressed in hours) being indicated on the abscissa and the resistivity of the functional layer (expressed in μOhm·cm) being indicated on the ordinate in the case of FIG. 1 and the LA/t ratio between the light absorption of the stack and the thickness of the functional layer (ratio expressed in μm⁻¹) being indicated on the ordinate in the case of FIG. 2.

In both these figures, comparative examples 1 and 2 are respectively referred to as “Ex. C1” and “Ex. C2”.

These results show that, in the absence of oxygen barrier layer or in the presence of a barrier layer made of silicon nitride but deposited at a pressure not in accordance with the invention, the material does not withstand high temperature aging for a period of time of greater than 150 h or 200 h, since the resistivity of the ITO layer increases very rapidly to reach very high values. The increase in the resistivity is associated with a marked decrease in the light absorption, which demonstrates that the mechanism of oxidation of the ITO by the oxygen of the air is clearly involved.

On the other hand, the presence of a barrier layer deposited according to the invention, in the presence or absence of an overlayer made of silicon oxide, makes it possible to obtain stacks which are particularly stable with regard to their properties of resistivity and thus of emissivity. The degree of oxidation of the ITO changes little over time. The materials thus obtained thus make it possible to retain their thermal properties in the context of an even intensive use, for example as oven doors or fireplace inserts.

1. A process for the manufacture of a material comprising a glass or glass-ceramic substrate provided, on at least one of its faces, with a stack of thin layers comprising a functional layer based on indium tin oxide, the process comprising successively depositing said functional layer and then, under a pressure of at most 2.5 μbar, an oxygen barrier layer by magnetron cathode sputtering on said at least one face of said substrate.

2. The process as claimed in claim 1, wherein the glass substrate is made of soda-lime-silica, borosilicate, aluminosilicate or alumino-borosilicate glass.

3. The process as claimed in claim 1, wherein the substrate is made of glass and the material is heat tempered.

4. The process as claimed in claim 1, wherein the oxygen barrier layer is based on a material chosen from nitrides or oxynitrides, or from titanium, zirconium or zinc oxides, or tin and zinc mixed oxides.

5. The process as claimed in claim 4, wherein the oxygen barrier layer is based on silicon nitride.

6. The process as claimed in claim 1, wherein the oxygen barrier layer has a physical thickness of at least 3 nm and at most 50 nm.

7. The process as claimed in claim 1, wherein a layer based on titanium oxide, the physical thickness of which is at most 30 nm is deposited above the oxygen barrier layer.

8. The process as claimed in claim 1, wherein a degree of oxidation of the functional layer is such that the ratio of the light absorption of the stack to the physical thickness of the functional layer, expressed in is within a range extending from 0.20 to 0.60.

9. The process as claimed in claim 1, wherein a functional layer and an oxygen barrier layer are deposited, by magnetron cathode sputtering, on each face of the substrate, the deposition of each oxygen barrier layer being carried out under a pressure of at most 2.5 μbar.

10. The process as claimed in claim 1, wherein the stack comprises, between the substrate and the functional layer, at least one neutralization layer or one neutralization stack of layers.

11. The process as claimed in claim 1, wherein the pressure for deposition of the oxygen barrier layer is at most 2.4 μbar.

12. A material capable of being obtained according to the process of claim 1.

13. A domestic oven door or fireplace insert, or fire-resistant door or glazing, comprising at least one material as claimed in claim 12.

14. The domestic oven door as claimed in claim 13, comprising three or four glass sheets, the second and/or the third glass sheet, starting from an internal glass sheet intended to be the glass sheet closest to a chamber of the oven, being made with said material.

15. A process for the manufacture of a domestic oven door, or of a fireplace insert, or of a fire-resistant door or glazing, comprising a stage employing the process of claim 1.

16. The process as claimed in claim 4, wherein the material is chosen from silicon or aluminum nitrides or oxynitrides.

17. The process as claimed in claim 6, wherein the oxygen barrier layer has a physical thickness of at least 4 nm and at most 30 nm.

18. The process as claimed in claim 11, wherein the pressure for deposition of the oxygen barrier layer is at most 2.1 μbar.

19. The domestic oven door as claimed in claim 13, wherein the oven door is a pyrolysis oven door.

20. The process for the manufactured of a domestic oven door as claimed in claim 15, wherein the domestic oven door is a pyrolysis oven door.
